(19) United States
(12) Patent Application Publication
(10) Pub. No.: US 2018/0336596 A1
(43) Pub. Date: Nov. 22, 2018

(54) Advertising System and Advertising Method

(71) Applicant: Shenzhen Goodix Technology Co., Ltd., Shenzhen (CN)

(72) Inventors: Wen-Chi Wang, Taipei City (TW); Yen-Yin Huang, Taipei City (TW)

(21) Appl. No.: 15/823,586

(22) Filed: Nov. 28, 2017

Related U.S. Application Data
(63) Continuation of application No. PCT/CN2017/084557, filed on May 16, 2017.

(51) Int. Cl. G06Q 30/02; H04N 21/442; G06K 9/46; G06T 1/00

(52) U.S. Cl. CPC G06Q 30/0267; G06T 1/0007; G06K 9/46; H04N 21/44218

(57) ABSTRACT

The present application provides an advertising system, which includes a signage device, wherein the signage device includes a display panel configured to play a video; a camera module configured to capture an image; a determining module configured to determine whether or not a human face exists in the image; a wireless transmission module, wherein the wireless transmission module transmits a connection information when the determining module determines that there is a human face in the image; a first communication module; and an user device, wherein the user device includes a wireless reception module; a second communication module; wherein the second communication module establishes a wireless connection with the first communication module according to the connection information when the wireless reception module receives the connection information, and the signage device transmits an audio signal to the user device via the wireless connection.

### CROSS REFERENCE TO RELATED APPLICATIONS

The present application is a continuation of international application No. PCT/CN2017/084557, filed on May 16, 2017, of which are incorporated herein by reference in its entirety.

### FIELD OF THE INVENTION

The present application relates to an advertising system and an advertising method, and more particularly, to an advertising system and an advertising method capable of broadcasting audio of advertisement to particular audience.

### BACKGROUND

Advertising promotes commercial product effectively, which also stimulates the purchase desire of consumers. Recently, as display technology evolves, advertisement may be broadcasted by a signage device, such as a signage, a large billboard or a television wall, disposed in public area such as a department store, a wholesale store, a front of a store, a railway station, etc. The signage device stated in the above plays the advertisement silently (or in a low volume). Potential consumers passing through only see the video part of the advertisement, but are not able to hear the audio part of the advertisement. Nevertheless, the advertising method stated in the above only involves advertisement pushing in sense of sight, which lacks of advertisement pushing in sense of auditory and reduces consumer's sensory experience. If the advertisement is played by a larger volume, it causes disturbance to pedestrians who are not interested in and is too noisy.

Therefore, it is necessary to improve the prior art.

### SUMMARY

It is therefore a primary objective of the present application to provide an advertising system and an advertising method capable of broadcasting audio of advertisement to particular audience, to improve over disadvantages of the prior art.

To solve the problem stated in the above, the present application provides an advertising system, comprising a signage device, comprising a display panel configured to play a video; a camera module disposed around or within the display panel and configured to capture an image; a determining module coupled to the camera module and configured to determine whether or not a human face exists in the image; a wireless transmission module coupled to the determining module, wherein when the determining module determines that there is a human face in the image, the wireless transmission module transmits a connection information; and a first communication module; and a user device comprising a wireless reception module and a second communication module; wherein when the wireless reception module receives the connection information, the second communication module establishes a wireless connection with the first communication module according to the connection information, the signage device transmits an audio signal to the user device via the wireless connection, and the audio signal comprises an audio corresponding to the video.

For example, when the determining module determines that there is a human face in the image, the wireless transmission module continuously transmits the connection information for a specific time.

For example, when the determining module determines that there is no human face in the image, the wireless transmission module does not transmit the connection information.

For example, the wireless reception module is periodically enabled, so as to detect whether or not the wireless transmission module transmits the connection information.

For example, when the wireless reception module receives the connection information, the wireless reception module generates a wake-up signal to the second communication module, such that the second communication module is switched from a sleep mode to a normal operation mode.

For example, the wireless transmission module is an ultrasound transmission module, the wireless reception module is an ultrasound reception module.

For example, the wireless transmission module is an infrared transmission module, the wireless reception module is an infrared reception module.

For example, the wireless transmission module stops transmitting the connection information after the second communication module establishes the wireless connection with the first communication module.

For example, the first communication module and the second communication module are WiFi modules, Bluetooth modules or near field communication (NFC) modules.

For example, the signage device is a television wall or a billboard.

For example, the user device is a wireless headphone or a mobile phone.

The present application further provides an advertising method comprising the signage device capturing an image and performing a face detection on the image, so as to determine whether or not a human face exists in the image; the signage device transmitting a connection information when the signage device determines that there is a human face in the image; the user device establishing a wireless connection with the signage device according to the connection information when the user device receives the connection information; and the signage device transmitting an audio signal to the user device via the wireless connection, wherein the audio signal comprises an audio corresponding to the video.

The present application further provides a signage device comprising a display panel configured to play a video; a camera module disposed around the display panel or within the display panel and configured to capture an image; a determining module coupled to the camera module and configured to determine whether or not a human face exists in the image; a wireless transmission module coupled to the determining module, wherein the wireless transmission module transmits a connection information to an user device when the determining module determines that there is a human face in the image; and a first communication module, configured to establish a wireless connection with the user device and transmit an audio signal to the user device, wherein the audio signal comprises an audio corresponding to the video.

The present application further provides a user device comprising a wireless reception module configured to receive a connection information; and a communication module coupled to the wireless reception module and configured to establish a wireless connection with a signage device according to the connection information and receive an audio signal from the signage device via the wireless connection.

The present application utilizes the camera module and the determining module of the signage device to perform face detection determining whether or not a human face exists in the image, and via the face detection to determine whether or not a consumer stops by the front of the signage device. When the consumer stares the signage device, the signage device connects the user device held by the consumer, and transmit the audio of the advertisement to the user device held by the consumer. Therefore, the present application may further enhance consumer's sensory experience, without disturbing other people.

These and other objectives of the present application will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an appearance of an advertising system according to an embodiment of the present application.

FIG. 2 is a functional block diagram of the advertising system of FIG. 1.

FIG. 3 is a schematic diagram of an advertising method according to an embodiment of the present application.

### DETAILED DESCRIPTION

In order to make the objects, technical solutions and advantages of the present application become more apparent, the following relies on the accompanying drawings and embodiments to describe the present application in further detail. It should be understood that the specific embodiments described herein are only for explaining the present application and are not intended to limit the present application.

The present application mainly performs face detection on the image captured around the signage (to determine whether or not there is a human face in the image), and has knowledge about whether or not there is potential consumer stopping by the front of the signage and interested in the advertisement content. If yes, the signage device may connect the user device brought by the consumer and send the audio of the advertisement to the user device brought by the consumer, such that the consumer may hear the audio of the advertisement from the user device. Therefore, the present application may enhance consumer's sensory experience in both of sense of sight and auditory, without disturbing other people.

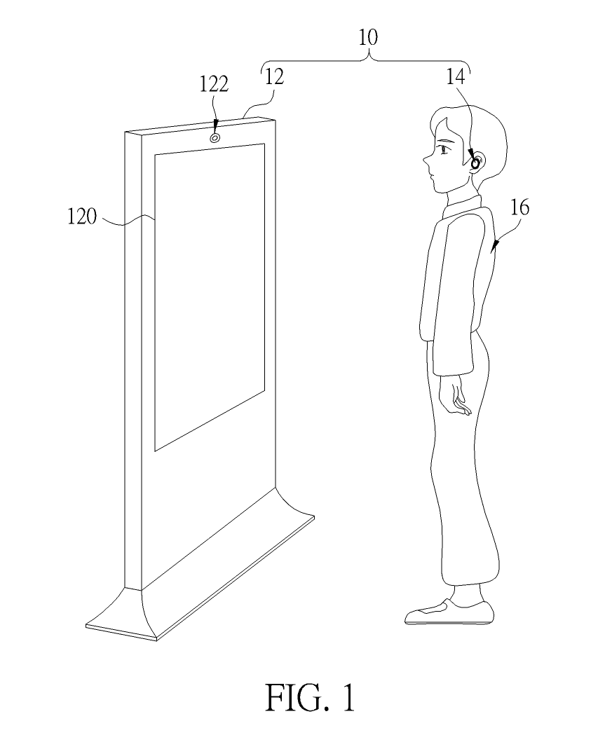

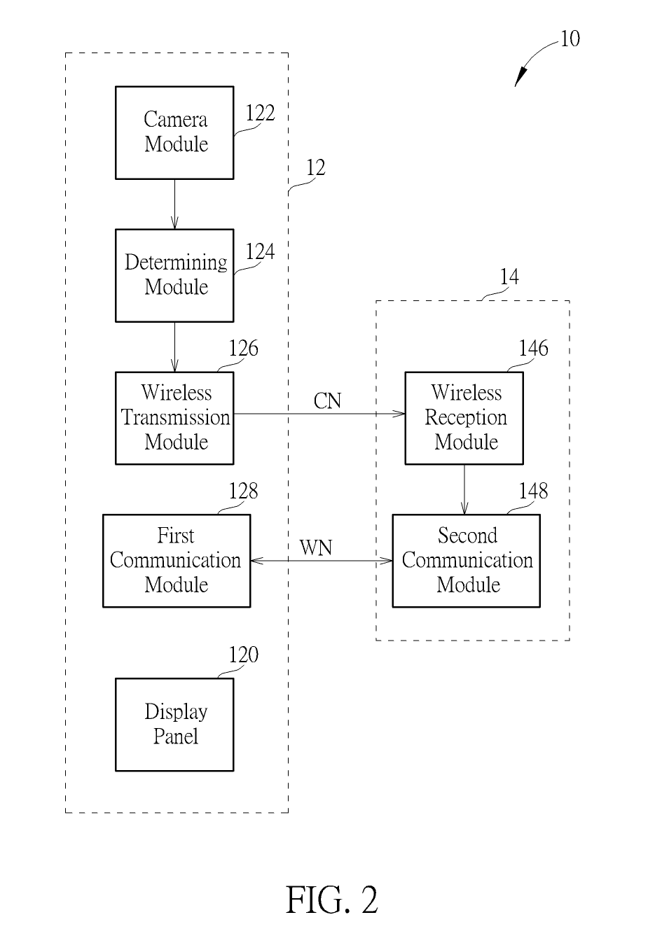

Specifically, please refer to FIG. 1 and FIG. 2. FIG. 1 and FIG. 2 are an appearance diagram and a functional block diagram of an advertising system 10, respectively, according to an embodiment of the present application. the advertising system 10 comprises a signage device 12 and a user device 14. The signage device 12 may be a digital electronic signage, which may be disposed in public place such as a department store, a wholesale store, a front of a store, a railway station, etc. The user device 14 is a wireless headphone. The signage device 12 comprises a display panel 120, a camera module 122, a determining module 124, a wireless transmission module 126 and a first communication module 128. The user device 14 comprises a wireless reception module 146 and a second communication module 148. The camera module 122 may comprise an optical lens and light sensing device/component such as charge-coupled device (CCD) or CMOS image sensor (CIS).

The wireless transmission module 126 and the wireless reception module 146 are a transmission module and a reception module using the same transmission medium, and the transmission medium is not easily perceived by human, e.g., ultrasound or infrared (IR). When the wireless transmission module 126 is an ultrasound transmission module, the wireless reception module 146 is an ultrasound reception module; when the wireless transmission module 126 is an infrared transmission module, the wireless reception module 146 is an infrared reception module. In other words, the wireless transmission module 126/the wireless reception module 146 may transmit/receive small data amount and consume less power. In comparison, the first communication module 128 and the second communication module 148 may transmit/receive large data amount and consume more power. In some embodiments, the first communication module 128 and the second communication module 148 are WiFi modules, Bluetooth (BT) modules or near field communication (NFC) modules.

The display panel 120 is configured to play only an video part of an advertisement. That is, through the display panel 120, audience/consumer only has visual on the video part of the advertisement. The camera module 122 may be disposed by an upper edge of the display panel 120, configured to capture an image in relative to the display panel 120, wherein the image in relative to the display panel 120 represents the image captured at the direction of which the display panel 120 displays, i.e., at the direct, perpendicular to the display panel 120, toward which the pixel displaying devices of the display panel 120 emit light. The determining module 124, coupled to the camera module 122, is configured to determine whether or not a human face exists in the image. Face detection techniques, determining whether or not a human face exists in the image, is known by the art, which is not narrated herein. In addition, the determining module 124 may be realized by application specific integrated circuit (ASIC), microcontroller (MCU) or central processing unit (CPU). The wireless transmission module 126 is coupled to the determining module 124. When the determining module 124 determines that there is a human face in the image, the determining module 124 may generate an informing signal to the wireless transmission module 126, to inform the wireless transmission module 126 to broadcast/transmit a connection information CN, where the connection information CN contains required connection information to establish a wireless connection with the first communication module 128, e.g., a service set identifier (SSID) for establishing a WiFi connection with the first communication module 128 or a password for establishing the wireless connection.

When the wireless reception module 146 of the user device 14 receives the connection information CN, the wireless reception module 146 may deliver the connection information CN to the second communication module 148, and the second communication module 148 may establish a wireless connection WN with the first communication module 128 according to the connection information CN. Once the wireless connection WN is established, the signage device 12 may utilize the first communication module 128 to transmit an audio signal to the user device 14 via the wireless connection WN. The audio signal, which may be a streaming audio signal, comprises an audio corresponding to the advertisement. It means that the audio signal comprises the audio corresponding to the video which is displayed by the display panel 120. After the user device 14 receives the audio signal, the user device 14 may decode the audio signal and play the audio of the advertisement via a speaker within the wireless headphone.

In short, when a consumer 16 stops by the signage device 12, the signage device 12 utilizes the camera module 122 to capture the image in relative to the display panel 120, and utilizes the determining module 124 to perform face detection on the image to determine whether or not a human face exists in the image. When the determining module 124 determines that there is a human face in the image, the signage device 12 utilizes the wireless transmission module 126 to transmit the connection information CN (which is required for establishing connection with the first communication module 128) to the user device 14 (which can be the headphone) held by the consumer 16. The user device 14 may establish the connection with the signage device 12 according to the connection information CN, so as to receive the audio of the advertisement. In such a condition, as long as the consumer 16 stands by the signage device 12 and stares at the content displayed on the display panel 120, the user device 14 (wireless headphone) held by the consumer 16 would automatically play the audio corresponding to the advertisement. There is no need for perform any (manually) setting on the user device 14, which brings usage convenience.

In addition, when the determining module 124 determines that there is a human face in the image, the wireless transmission module 126 may continuously transmit the connection information CN for a specific time (e.g., 3 to 5 seconds). In an embodiment, after the wireless transmission module 126 repeatedly transmits the connection information CN for the specific time, the wireless transmission module 126 may cease transmitting the connection information CN. In contrast, when the determining module 124 determines that there is no human face in the image, the wireless transmission module 126 may not transmit the connection information CN.

In another perspective, the wireless reception module 146 of the user device 14 is shut off or disabled most of the time but is active or enabled periodically. For example, the wireless reception module 146 may take one second as one period, and be active or enabled for one (or multiple) millisecond(s) in every one second period, so as to detect whether the wireless transmission module 126 transmits the connection information CN. In addition, to save electric power, the second communication module 148 of the user device 14 may be in a sleep mode most of the time. Once the wireless reception module 146 receives the connection information CN, the wireless reception module 146 may generate a wake-up signal to the second communication module 148, such that the second communication module 148 is switched from the sleep mode to the normal operation mode and establishes the wireless connection WN with the first communication module 128. After the second communication module 148 establishes the wireless connection WN with the first communication module 128, the wireless transmission module 126 of the signage device 12 may cease transmitting the connection information CN.

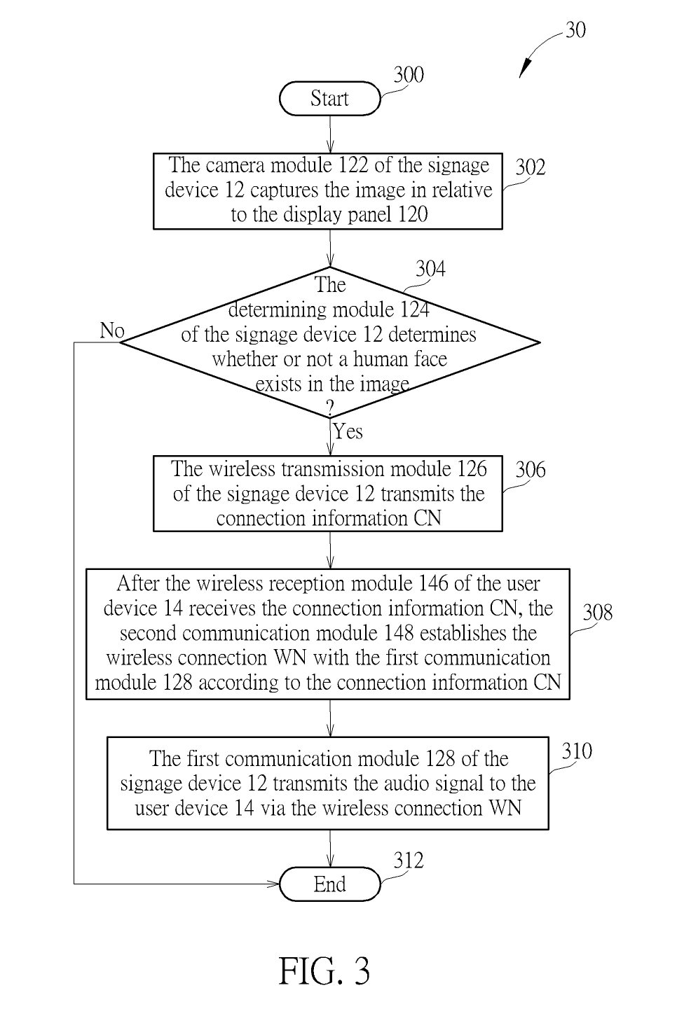

Operation of the advertising system 10 may be summarized into a process. Please refer to FIG. 3, which is a schematic diagram of an advertising method 30 according to an embodiment of the present application. The advertising method 30 may be executed by the advertising system 10. As shown in FIG. 3, the advertising method 30 comprises following steps:

Step 300: Start.

Step 302: The camera module 122 of the signage device 12 captures the image in relative to the display panel 120.

Step 304: The determining module 124 of the signage device 12 determines whether or not a human face exists in the image? If yes, go to Step 306; otherwise, go to Step 312.

Step 306: The wireless transmission module 126 of the signage device 12 transmits the connection information CN.

Step 308: After the wireless reception module 146 of the user device 14 receives the connection information CN, the second communication module 148 establishes the wireless connection WN with the first communication module 128 according to the connection information CN.

Step 310: The first communication module 128 of the signage device 12 transmits the audio signal to the user device 14 via the wireless connection WN.

Step 312: End.

Details of the advertising method 30 may be referred to the paragraphs in the above, which is not narrated herein.

Notably, the embodiments stated in the above are utilized for illustrating the concept of the present application. Those skilled in the art may make modifications and alterations accordingly, and not limited herein. For example, the signage device is not limited to be the digital electronic signage. The signage device may be a digital electronic billboard or a television wall, which is also within the scope of the present application. In addition, the user device is not limited to be the headphone. The user device may be an electronic device held by a single user, e.g., a mobile phone, a tablet, which is also within the scope of the present application. In addition, the camera module is not limited to be disposed by the upper edge of the display panel. The camera module may be disposed by a left edge, a right edge or a bottom edge. Furthermore, for a large signage device, the camera module may be disposed between the pixel displaying devices of the display panel, i.e., the camera module may be disposed within the display panel, which is also within the scope of the present application.

In summary, the present application utilizes face detection to determine whether or not a consumer stops by the front of the signage device. When the consumer stares the signage device, the signage device connects the user device held by the consumer, and transmits the audio of the advertisement to the user device held by the consumer. Therefore, the present application may enhance consumer's sensory experience, without disturbing other pedestrians/people. Moreover, the present application utilizes the camera module and the determining module of the signage device to perform face detection determining whether or not a human face exists.

The foregoing is only preferred embodiments of the present application, it is not intended to limit the present application, any modifications within the spirit and principles of the present invention, equivalent replacement and improvement, etc., should be included within the scope of the application.

What is claimed is:

1. An advertising system, comprising:
a signage device, comprising:
a display panel, configured to play a video;
a camera module, disposed around the display panel or within the display panel, configured to capture an image;
a determining module, coupled to the camera module, configured to determine whether or not a human face exists in the image;
a wireless transmission module, coupled to the determining module, wherein the wireless transmission module transmits a connection information when the determining module determines that there is a human face in the image; and
a first communication module; and
a user device, comprising:
a wireless reception module; and
a second communication module;
wherein the second communication module establishes a wireless connection with the first communication module according to the connection information when the wireless reception module receives the connection information, and the signage device transmits an audio signal to the user device via the wireless connection, and the audio signal comprises an audio corresponding to the video.

2. The advertising system as claim 1, wherein when the determining module determines that there is a human face in the image, the wireless transmission module continuously transmits the connection information for a specific time.

3. The advertising system as claim 1, wherein when the determining module determines that there is no human face in the image, the wireless transmission module does not transmit the connection information.

4. The advertising system as claim 1, wherein the wireless reception module is periodically enabled, so as to detect whether or not the wireless transmission module transmits the connection information.

5. The advertising system as claim 1, wherein when the wireless reception module receives the connection information, the wireless reception module generates a wake-up signal to the second communication module, such that the second communication module is switched from a sleep mode to a normal operation mode.

6. The advertising system as claim 1, wherein the wireless transmission module is an ultrasound transmission module, the wireless reception module is an ultrasound reception module.

7. The advertising system as claim 1, wherein the wireless transmission module is an infrared transmission module, the wireless reception module is an infrared reception module.

8. The advertising system as claim 1, wherein the wireless transmission module stops transmitting the connection information after the second communication module establishes the wireless connection with the first communication module.

9. The advertising system as claim 1, wherein the first communication module and the second communication module are WiFi modules, Bluetooth modules or near field communication (NFC) modules.

10. The advertising system as claim 1, wherein the signage device is a television wall, a billboard or a signage.

11. The advertising system as claim 1, wherein the user device is a wireless headphone or a mobile phone.

12. An advertising method, wherein the advertising method is applied in an advertising system, the advertising system comprises a signage device and a user device, the signage device plays a video, and the advertising method comprises:
the signage device capturing an image and performing a face detection on the image, so as to determine whether or not a human face exists in the image;
the signage device transmitting a connection information when the signage device determines that there is a human face in the image;
the user device establishing a wireless connection with the signage device according to the connection information when the user device receives the connection information; and
the signage device transmitting an audio signal to the user device via the wireless connection, wherein the audio signal comprises an audio corresponding to the video.

13. The advertising method as claim 12, further comprising:
the signage device continuously transmitting the connection information for a specific time when the signage device determines that there is a human face in the image.

14. The advertising method as claim 12, further comprising:
the signage device transmitting no connection information when the signage device determines that there is no human face in the image.

15. A signage device, comprising:
a display panel, configured to play a video;
a camera module, disposed around the display panel or within the display panel, configured to capture an image;
a determining module, coupled to the camera module, configured to determine whether or not a human face exists in the image;
a wireless transmission module, coupled to the determining module, wherein the wireless transmission module transmits a connection information to an user device when the determining module determines that there is a human face in the image; and
a first communication module, configured to establish a wireless connection with the user device, and transmit an audio signal to the user device, wherein the audio signal comprises an audio corresponding to the video.

16. The signage device as claim 15, wherein when the determining module determines that there is a human face in the image, the wireless transmission module continuously transmits the connection information for a specific time.

17. The signage device as claim 15, wherein the wireless transmission module is an ultrasound transmission module or an infrared transmission module.

18. The signage device as claim 15, wherein the wireless transmission module stops transmitting the connection information after the first communication module establishes the wireless connection with the user device.

19. The signage device as claim 15, wherein the first communication module is a WiFi module, a Bluetooth module or a near field communication (NFC) module.

20. The signage device as claim 15, wherein the signage device is a television wall, a billboard or a signage.
